(19) United States
(12) Patent Application Publication
(10) Pub. No.: US 2003/0078869 A1
(43) Pub. Date: Apr. 24, 2003

(54) Interactive control interface for evaluating and executing a strategy for controlling investment risk

(76) Inventor: James Benjamin Williams, Sherborn, MA (US)

Correspondence Address: CHARLES G. CALL, 68 HORSE POND ROAD, WEST YARMOUTH, MA, 02673-2516, US

(21) Appl. No.: 10/273,592

(22) Filed: Oct. 19, 2002

Related U.S. Application Data
(60) Provisional application No. 60/348,035, filed on Oct. 19, 2001.

(51) Int. Cl. G06F 17/60; G09G 5/00

(52) U.S. Cl. 705/36; 345/771

(57) ABSTRACT

An interactive control implemented using HTML web pages and Java applets for selecting and displaying the characteristics of an investment strategy designed to provide acceptable returns within acceptable risks to a user. The user first selects a benchmark combination of standard investment products and then adjust the characteristics of a graphically presented risk transfer function in order to define the relationship between gains and losses experienced by the selected standard investment products and a desire gain and loss performance. The user may then display a simulation of the performance of the selected investment. When satisfied with the characteristics defined using the portfolio, the user can then obtain actual investment products to provide the performance characteristic defined using the interactive control.

### CROSS-REFERENCE TO RELATED APPLICATION

This application claims the benefit of the filing date of the copending U.S. Provisional Patent Application Serial No. 60/348,035 filed on Oct. 19, 2001.

### REFERENCE TO COMPUTER PROGRAM LISTING APPENDIX

A computer program listing appendix is stored on each of two duplicate compact disks which accompany this specification. Each disk contains computer program listings that illustrate implementations of the invention. The listings are recorded as ASCII text in an IBM PC/MS DOS compatible file (70 kilobytes) having the filename “Appendix.txt” created Oct. 18, 2002.

### FIELD OF THE INVENTION

This invention relates to methods and apparatus for evaluating investment risk and for investing in a plurality of diverse investment products in order to transfer investment risk from the investor to counterparties.

### SUMMARY OF THE INVENTION

In a principal aspect, the present invention takes the form on an interactive control that displays variables and computational results that enables a user to select the characteristics of an investment strategy that will provide acceptable returns within acceptable risks.

The control provides means for accepting from the user a selection of a benchmark combination of standard investments having different risk characteristics, typically stocks, bonds, and treasury bills. Certainly, more benchmarks or indexes can be included. Alternatively, the “benchmark” as used in the rest of this description can be the user's own portfolio of securities for which an “insurance” or risk modifying instrument is sought. The user allocates the extent of investment in each selected investment products. The control further presents to the user, and permits the user to adjust, a graphical representation of the “risk transfer function” that defines the manner in which the user wishes to participate in the returns that would be produced by the benchmark combination previously specified. The graphical representation of the risk transfer function, which may be implemented by a continuous curve or a curve represented by plural connected straight line segments, may be reshaped by the user by means of an input device such as a mouse to redefine the risk transfer characteristic. In this way, the user can vary limits placed on the amount of potential loss or potential gain, or the rate at which loss and gain varies relative to the loss or gain experienced by the benchmark securities.

The interactive control thereby permits the user to define the characteristics of an aggregation of investments which may include selected benchmark securities, put and call options, and other standard investment products which will provide or simulate the characteristics graphically by the user using the interactive control.

The interactive control may also be used to define the terms of an investment contract or product which is purchase by the user/investor from an issuer/counterparty.

These and other features of the invention will become more apparent through a consideration of the following detailed description of an illustrative embodiment of the invention. In the course of this description, frequent reference will be made to the attached drawings.

### BRIEF DESCRIPTION OF THE DRAWINGS

FIG. 1 depicts a control used to allocate the components of a benchmark investment portfolio;

FIGS. 2-4 illustrate the form and operation of control that defines a risk transfer function to be applied to the returns of the benchmark portfolio;

FIG. 5 depicts a performance charting control used to simulate the performance of the investment contract designed by the user;

FIG. 6 shows a combined control page for concurrently viewing and manipulating several controls seen in a single view; and

FIG. 7 is a flow chart illustrating the use of the interactive tool contemplated by the invention.

### DETAILED DESCRIPTION

A demonstration program which provides an illustrative embodiment of the invention is set forth in detail in the accompanying computer program listing appendix which details a demonstration program which may be executed using a web browser program for displaying pages implemented as shown in the HTML listings which employ embedded functionality provided by Java applets shown in the Java listings. This demonstration program allows an individual investor to explore the ability to transfer investment risk to counterparties. This program permits the investor to assemble a group of separate investments that together achieve the goals defined by individual investor.

The system works by taking a distribution of expected returns over a defined time period (one year in the demonstration version), defining and applying a risk transfer function, and ‘pricing’ the contract by balancing the expected returns the user sees with those the counterparty would see. Thus, to the extent the investor chooses to limits his downside risk, the resulting investment product reduces the upside as well, based on the distribution.

The issuer (counterparty) of the investment product can be compensated by biasing the distribution. The issue of the product may simply charge basis points, but the method of analysis provided by the invention is open ended, and a risk transfer function of any shape can be applied. As described below, graphical tools permit the user to shape the transfer function by moving linear elements which define a transfer function. The arrangement shown may be modified by providing a plurality of preconstructed transfer function shapes, including shapes having negative slopes (indicating going short).

An individual may design an investment product tailored to his or needs or preferences. Such a product, here called a Parameterized Risk Contract (or “PaRC”) permits the investor to specify limits on losses, and how the investor will participate in the returns from the investments made. Most importantly, during the process, the investor is shown how the risk/return parameters that the investor chooses are likely to affect the return the investment will provide in the future over one or over multiple time periods [as shown]. Actual returns are, of course, not guaranteed. The investor follows a program-guided procedure, and is supplied with complete instructions and explanations at each step of the process.

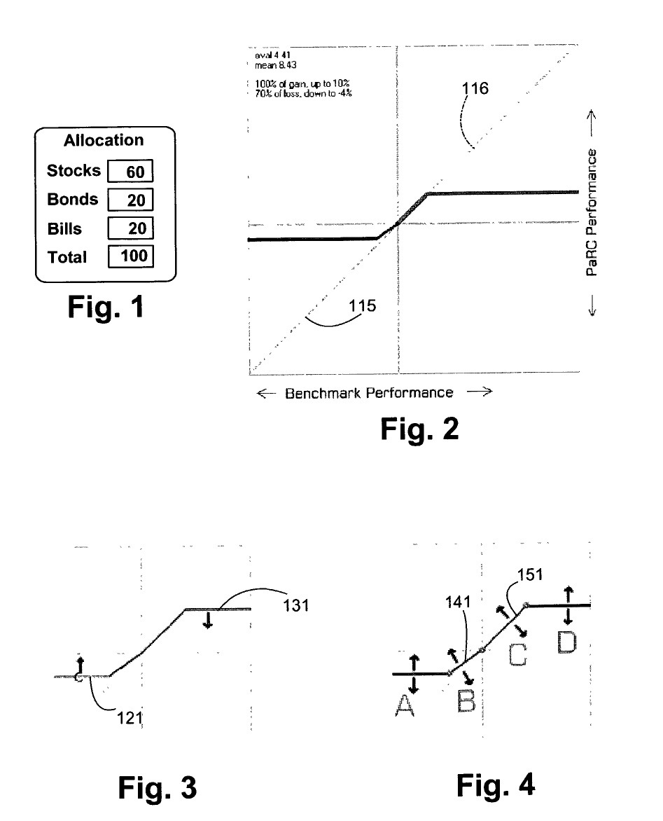

First, the user selects a benchmark combination of standard investments having different risk characteristics, typically stocks, bonds, and treasury bills that will be the basis for the Parametized Risk Contract investment. Using the allocation control 101 shown in FIG. 1, the user enters allocation amounts for each investment type. The allocation control automatically adjusts the other amounts when any allocation is changed by the user so that the sum of the three amounts allocated to stocks, bond and bills is 100.

When the user has finished providing an allocation of the three investments that will form the basis for the PaRC investment, the user then adjusts the risk transfer function shown in FIGS. 2-4. The adjustment of the Risk Transfer Function (RTF) allows the investor to specify how he or she wants to participate in the returns of the investment. The adjustable RTF implemented in FIGS. 2 and 3 comprises a segmented line function which is presented on a two-dimensional graph in which the vertical dimension represents the performance of the PaRC contract and the horizontal dimension represents the performance of the benchmark investment defined by the allocation control shown in FIG. 1. Thus, if the transfer function used was simply the diagonal straight line 115 and 116, the PaRC contract and the benchmark investment defined by the allocation control would perform the same.

The RTF adjustment control shown in FIGS. 2-5 permits the user to alter the transfer function by using a mouse to click on and move (“drag”) the line segment 121 in a vertical direction A as shown in FIG. 3 to move the loss limit up, reducing possible loss, in response to which the RTF control automatically causes the gain limit segment 131 to move down, reducing the maximum amount of gain that can be expected. In like fashion, if the user instead moves the upper gain limit segment 131 up or down, the loss limit segment 121 moves up or down accordingly. Clicking the price segment swaps with the current input segment. The user can select a different ‘price’ or output segment by double-clicking it. The user can then modify the slope or level of a the selected segment, and any other segment will be automatically moved or reshaped in response to indicate the complete, priced RTF.

The user may also change the slope of the line segment 141 as shown in FIG. 3 to change the rate of loss so that it is greater than, equal to, or less than the rate of loss of the benchmark indicated by the diagonal line at 115 seen in FIG. 2. Likewise, the user can use the mouse to change the slope of line segment 151 from the benchmark rate of gain indicated by the diagonal line 116 in Fig. so that the rate of gain of the PaRC is less than, greater than, or equal to the rate of gain of the benchmark portfolio.

Thus, the investor (or issuer) can design a tailor-made investment product (a Parameterized Risk Contract), by reducing the effect of losses and setting limits on the amount your portfolio can drop in a given year. But, as the automated Risk Transfer Control of FIGS. 2-5 demonstrates, there is no “free lunch,” since reducing the effects of losses also reduces the gains to be expected.

The Risk Transfer Control allows the user to adjust line segment 121 to designate the worst loss, thereby insuring that the PaRC will never lose more than this percentage of the investment. The slope of the line segment 131 sets the loss rate which can be the same as the benchmark allocation, or reduced or increased. Thus the PaRC designer may desire that the PaRC suffer losses a 50 cent loss for every one dollar drop in the benchmark value. Setting the slope of the line segment 151 allows the PaRC designer to adjust the rate of gain to be achieved. Thus, the designer may wish to accept a lower rate of gain by reducing the slope of line segment 151 in order to achieve a greater gain before the limit specified by line segment 131 is reached In accordance with the invention, the performance of the PaRC defined by the combination of the benchmark allocation (FIG. 1) and the risk transfer function specified by the RTF control (FIGS. 2-4) is shown to the user under various conditions which correspond either to historical performance of the benchmark investments, or performance based on statistical parameters that the user can set.

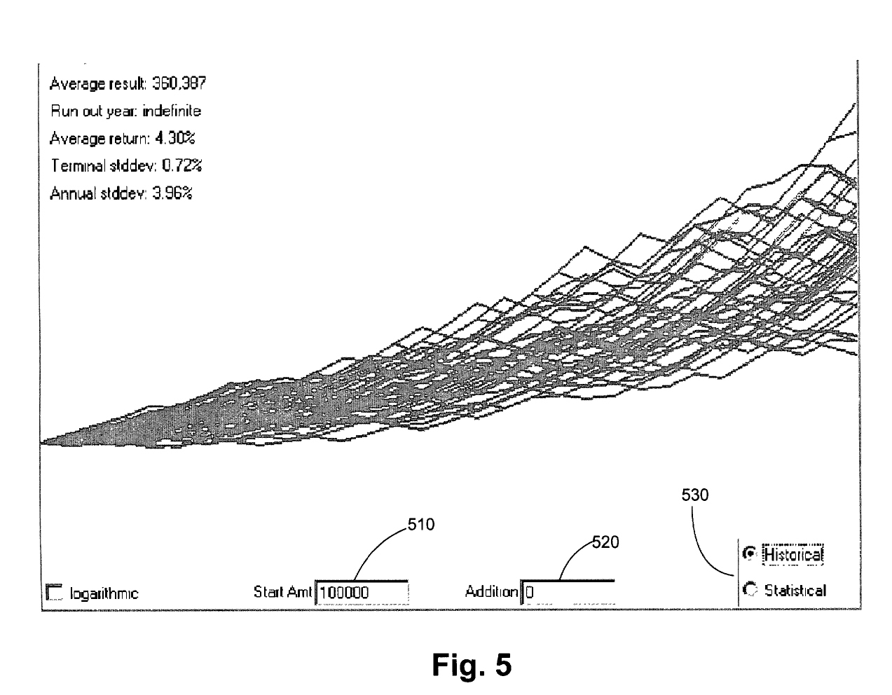

This user employs a performance charting control which employs the display illustrated in FIG. 5. The chart makes repeated simulations of the performance of the PaRC in the future under various conditions. You user can change the initial investment amount entered at 510, the amount of periodic payments added (or negative numbers for periodic withdrawals) at 520. Because the system uses “real” (inflation adjusted) investment returns, the user can assume that the addition or withdrawal amount also grows with inflation.

The future performance of the PaRC is charted using mean-variance modeling by selecting the “probabilistic” option on the radio button control at 530. Alternatively, the charting may be based on historical data, adjusted for inflation. In the implementation described in the appendix, actual asset class returns from 1872 to 2001, adjusted for inflation, were employed.

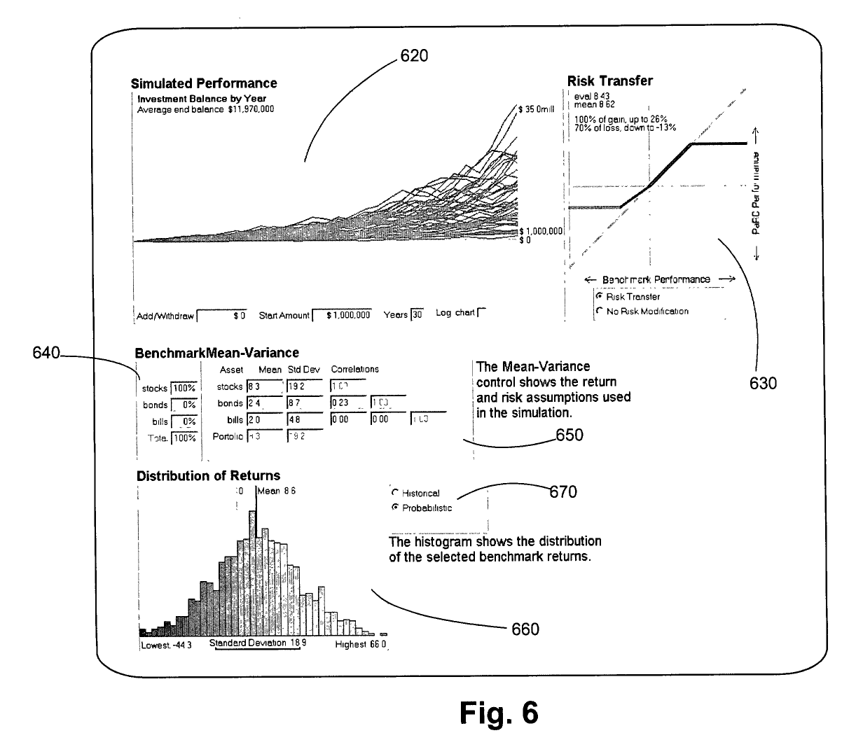

As illustrated in FIG. 6, all of these controls can be combined on a single control panel 610 which includes a performance charting control at 620, a Risk Transfer Function control at 630, and a benchmark allocation control at 640. A statistics control seen at 650 enables the user to vary the mean-variance statistics used in the statistical performance simulations. In addition, a histogram seen at 660 shows the distribution of the returns produced for the selected benchmark investments during the simulation. A radio button control a t 670 allows the user to switch between historical and statistical simulations.

The user interface controls described above may be employed as a tool that enables an individual investor to select and purchase a combination of available investment products which are calculated to better achieve the user's goals within acceptable risks. The tool may advantageously include a communications interface for obtaining current market data from available sources that may be specified by predetermined Internet URLs (Uniform Resource Locators). The retrieved data contains information on basic available risk transfer instruments (puts, calls, traded structured products), as well as the price of borrowing and lending cash. The prices of these instruments, along with their specifications such as strike price and expiration, are then used to construct a distribution used in the modeling. The tool permits the user to manipulating the transfer function within the constraints imposed by model to define different combinations of borrowing or keeping cash (the slope) and available put and call options used to set the lower and upper bounds on gains and losses. This method does may be used to include stock/bond index funds and individual stocks within the designed portfolio.

The foregoing use of the tool requires no counterparty to issue a designed investment product which possesses the designed risk characteristics. Instead, the investor assembles and purchases a combination of available investments which are selected and allocated by the tool in order to meet the investor's needs as specified with the tool. If the distribution of returns is known, then it is easy to price options and more complicated transfer functions or “participations”. The problem is that the market does not provide a steady distribution of risk in the same way that may be achieved, for example, by the games provided in a casino, which do not suffer from booms and recessions, terror attacks and or corporate deceit. A simplified and more continuous risk distribution may be offered to the investor by a counterparty. The investor uses the tool provided by the counterparty, the tool serving as a mechanism for offering a defined investment product here called a “parameterized risk product” which the counterparty is willing to provide under the terms specified by the tool.

The process used a known modeling distribution and then constructs a “martingale,” a term with multiple dictionary definitions:

1. A device that keeps a horse's head in position with its rows of teeth more or less horizontal;

2. A gambling strategy that involves betting one unit, then doubling the bet, until the gambler wins. The strategy appears to assure the gambler a profit of one unit at the end of each string of bets. The problem is that the gambler's—and house's—resources are finite. Consequently, the strategy isn't operational.

3. A stochastic process for which the expected change equals zero, e.g., equivalent martingale measure (q.v.). During the 1960s the martingale stochastic process was a standard model for a fair game, hence for stock price movements in an efficient market.

Example: Consider the probability measure that assigns a probability of ½ to a head or a tail, and for which successive coin tosses are independent. Then let X(n) be the random variable that starts at zero and increases by one with each “heads” outcome and decreases by one with each “tails” outcome. Then E[X(n)−X(n−1)|X(n−1)]=½(1)+½(−1)=0, and X(n) is a “martingale.”

A “martingale measure” is any probability measure (q.v.) under which a stochastic variable is a martingale, i.e., its expected change equals zero. A casino uses a martingale and hence does not care whether people at the roulette wheel always bet red or black. With no green squares, it is likely that sooner or later losses will balance wins and, with no green squares, the casino is assured of winning in the long run. The casino does not need a red-green bias against the gambler, but must commit capital to the inevitable strings of losses, and that stand-by capital deserves a return. It will be noted that insurance companies use the same principle.

In practice, because of the unbalanced or unknowable nature of markets, a serious counterparty will want to be able to hedge his net position against the PaRC investors, and that means that market prices of hedging must appear in the fees or in the distribution.

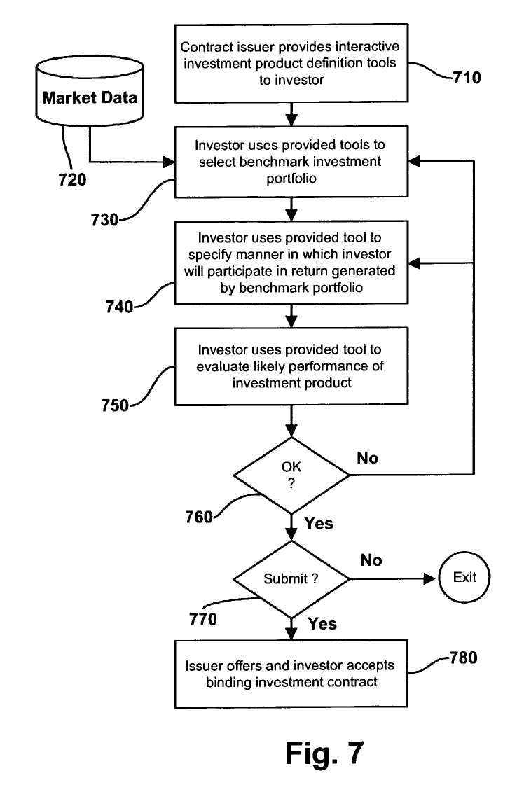

The manner in which the invention may be employed by an individual investor to define and purchase a tailor-made, Parametized Risk Contract from a counterparty is illustrated in FIG. 7 of the drawings. As seen at 710, the investor obtains and uses the interactive tool, typically provided by the counterparty or its representative, either by accessing an Internet resource which provides the interface or by downloading client side software that executes locally to present the design interface to the user. In addition, as indicated at 720, data is provided by the counterparty, or retrieved from other sources, reflecting current market conditions, prices, and/or the counterparty's current estimate of market distributions for individual benchmarks and combinations of benchmarks (using mean-variance modeling for combinations), as well as the cost of capital, probable runs of losses (insurance style), and/or the cost of hedging from the markets (Wall Street style).

Once the designer has interactively selected a benchmark portfolio and selected performance characteristics as seen at 730 and 740, the investor then use the tool to evaluate the likely performance of the selected investments as shown at 750. If that performance is found to be satisfactory, the user may accept those selections at 760 and submit them to the counterparty at 770. The counterparty and the investor may then enter into a contract at 780 that includes the parameters that were specified by the investor using the interactive tool.

It is to be understood that the specific methods, controls, and programs are merely illustrative applications of the principles of the invention. Numerous modifications may be made by those skilled in the art without departing from the true spirit and scope of the invention.

What is claimed is:

1. An interactive control for selecting and displaying the characteristics of an investment strategy designed to provide acceptable returns within acceptable risks to a user, said control comprising, in combination,
input means for accepting from said user a selection of a benchmark combination of standard investment products having different risk characteristics,
means for displaying a graphical representation of the relationship between returns to be produced by said benchmark combination of standard investment products and a desired actual return to be provided to said user,
input means for accepting modifications to the shape of said graphical representation,
a source of data indicating the probable performance of a plurality of alternative investments,
means responsive to said modifications and to said data for determining and displaying a new representation of an actual return achievable an actual investment in selected ones of said investment products and alternative investments.

2. The interactive control as set forth in claim 1 wherein said standard investment products comprise stocks, bonds, and treasury bills.

3. The investment control as set forth in claim 2 wherein said alternative investments include one or more option contracts.

4. The interactive control set forth in claim 1 further including means for displaying a simulation of the performance of said actual investment.

5. The interactive control set forth in claim 1 wherein said graphical representation depicts gains and losses which are to be provided to the investor relative to corresponding gains and losses experienced by said benchmark combination of standard investment products.
